(19) United States
(12) Patent Application Publication
(10) Pub. No.: US 2011/0009514 A1
(43) Pub. Date: Jan. 13, 2011

(54) Silane-Coupled Propylene-Based Polymer and Method

(75) Inventors: Bharat I. Chaudhary, Princeton, NJ (US); John Scott Parent, Kingston (CA); Malcolm F. Finlayson, Houston, TX (US); John D. Weaver, Pearland, TX (US); Rongjuan Cong, Lake Jackson, TX (US); Jian Wang, Rosharon, TX (US)

Correspondence Address: WHYTE HIRSCHBOECK DUDEK S.C./DOW;Intellectual Property Department, 555 East Wells Street, Suite 1900, Milwaukee, WI, 53202, US

(73) Assignees: Dow Global Technologies Inc., Midland, MI (US); Queen;s University at Kingston, Kingston (CA)

(21) Appl. No.: 12/831,348

(22) Filed: Jul. 7, 2010

Related U.S. Application Data
(60) Provisional application No. 61/223,794, filed on Jul. 8, 2009.

(51) Int. Cl. C08G 77/00; C08F 110/06

(52) U.S. Cl. 521/143; 526/351; 525/106; 521/154

(57) ABSTRACT

The present disclosure provides propylene-based polymers which exhibit a strain hardening distribution factor that is less than zero and/or a strain hardening factor greater than 1.5. The propylene-based polymers are rheology-modified by way of silane coupling to improve melt strength.

### CROSS-REFERENCE TO RELATED APPLICATIONS

This application claims the benefit of U.S. Provisional Application No. 61/223,794 filed Jul. 8, 2009.

### BACKGROUND

Polypropylene has a linear structure resulting in low melt strength which makes it ill-suited for certain melt state processes. Accordingly, polypropylene with linear structure is unsuitable for applications such as blown films, extrusion coating, foam extrusion, and blow-molding. Known are chemical processes that modify polypropylene to increase its melt strength. For example, it is known to increase melt strength by generating long-chain branching (LCB) through chemical modification of polypropylene—i.e., azide coupling, electron beam radiation, free radical functionalization. The demand for polypropylene continue to grow as applications for polypropylene become more diversified and sophisticated. Consequently, the art has a continuous need to develop alternate technologies for enhancing the properties of polypropylene.

Desirable is a propylene-based polymer with enhanced melt strength. Further desired is an improved process for producing propylene-based polymer with long-chain branching to improve melt strength.

### SUMMARY

The present disclosure is directed to olefin-based polymers, and in particular, propylene-based polymers with improved melt strength. The rheology of the propylene-based polymers may be modified by introducing long chain branching into the polymer structure which improves its melt strength. The rheology of the olefin-based polymers of this disclosure, e.g., extensional viscosity, demonstrates the present polymers are particularly suited for foaming applications.

In an embodiment, a polymer composition is provided. The polymer composition includes a propylene-based polymer having a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹.

The SHDF is based on a strain hardening factor (SHF). The SHF is the ratio of the extensional viscosity to three times of the shear viscosity at the same measurement time and at the same temperature. In an embodiment, the polymer composition has an SHF greater than 1.5.

The SHDF and SHF values for the polymer composition are the result of unique long chain branching (LCB) that is present in the propylene-based polymer. In an embodiment, the polymer composition has a weight averaged long chain branching index, g′_{lcb}, that is less than 0.99. In a further embodiment, the polymer composition includes a LCB high molecular weight (HMW) component and a LCB low molecular weight (LMW) component. The HMW component has a higher level of long chain branching than does the LMW component.

The present disclosure provides a process for producing the polymer composition. In an embodiment, a process is provided which includes moisture curing a silane-grafted propylene-based polymer in the presence of a moisture curing catalyst. The process further includes forming a silane-coupled propylene-based polymer. The silane-coupled propylene-based polymer has a strain hardening distribution factor (SHDF) less than 0.

In an embodiment, the moisture-curing catalyst is a sulfonic acid.

The present disclosure provides a foam composition. In an embodiment, a foam composition is provided which includes a propylene-based polymer that has a SHDF less than 0. The foam composition has a density from about 5 kg/m³ to about 850 kg/m³. In an embodiment, the propylene-based polymer is a silane-coupled propylene-based polymer.

An advantage of the present disclosure is a propylene-based polymer composition with improvement in one or more of the following properties: melt strength, extensional viscosity, strain hardening, and/or long chain branching.

An advantage of the present disclosure is an improved process for the production of a coupled propylene-based polymer which decreases the cure time.

An advantage of the present disclosure is an improved foam composition composed of a coupled propylene-based polymer.

### BRIEF DESCRIPTION OF THE DRAWINGS

FIGS. 1A-1D each is a graph showing the strain hardening factor for a respective example in accordance with an embodiment of the present disclosure.

FIG. 2 is a graph showing the strain hardening distribution factor for polymers in accordance with an embodiment of the present disclosure.

FIG. 3 is a Mark-Houwink plot in accordance with an embodiment of the present disclosure.

FIGS. 4a-4c are graphs showing Gel Permeation Chromatography data in accordance with an embodiment of the present disclosure.

FIGS. 5a-5d are graphs showing rheological data in accordance with an embodiment of the present disclosure.

FIGS. 6a-b are graphs showing rheological data in accordance with an embodiment of the present disclosure.

### DETAILED DESCRIPTION

In an embodiment, a polymer composition is provided. The polymer composition includes a propylene-based polymer having a strain hardening distribution factor (SHDF) less than 0. The polymer composition exhibits unique and distinct melt flow properties.

The strain hardening distribution factor is based on the unique extensional flow of the polymer composition. Extensional flow, or deformation that involves the stretching of a viscous material, is a common deformation that occurs in typical polymer processing operations. Extensional melt flow measurements are useful in polymer characterization because they are sensitive to the molecular structure of the polymeric system being tested. Polymer materials subject to extensional strain generate a higher degree of molecular orientation and stretching than materials subject to simple shear. As a consequence, extensional flows are sensitive to micro-structural effects, such as long-chain branching, and as such can be more descriptive with regard to polymer characterization than other types of bulk rheological measurements.

Strain hardening occurs when areas of material which have already been strained become stiffer, transferring subsequent elongation into areas which are unstrained. During strain hardening, the extensional viscosity of the material increases as the strain increases. As used herein, the term “strain hardening factor” (or “SHF”) is the ratio of the extensional viscosity to three times the shear viscosity measured at the same measurement time and at the same temperature. The “measurement time” is defined as the ratio of 3 to the applied Hencky strain rate in the extensional viscosity measurement. For example, the measurement time is 0.3 second for a strain rate of 10 s⁻¹, 3.0 second for a strain rate of 1 s⁻¹ and/or 30 seconds for a strain rate of 0.1 s⁻¹.

The term “Hencky strain,” as used herein, is denoted by \acute{ε} and is defined by the formula \acute{ε}=\acute{ε}_{H}×t, wherein the Hencky strain rate \acute{ε}_{H} is defined by the formula (I):

$${ɛ}_{H}^{′} = \frac{2 \cdot Ω \cdot R}{{L}_{o}} [ {s}^{- 1} ] \qquad ( I )$$

wherein “Lₒ” is the fixed, unsupported length of the specimen sample being stretched which is equal to the centerline distance between the master and slave drums, “R” is the radius of the equi-dimensional windup drums, and “Ω” is a constant drive shaft rotation rate.

The term “shear viscosity,” as used herein, is a measurement of the resistance to flow. A flow field can be established in a system by placing the sample between two parallel plates and then rotating one plate while the other plate remains static. Shear viscosity is determined by the ratio of shear stress to shear rate. For parallel plate setup, shear stress is determined by

$$τ = \frac{2 M}{π {R}^{3}} ,$$

where M is the torque applied by the instrument, R is the radius of the plates. Shear rate is determined by

$$\dot{γ} = \frac{R Ω}{h} ,$$

where Ω is the angular rotation rate and h is the gap between the plates.

In an embodiment, the polymer composition has a strain hardening factor greater than 1.5, or from about 1.5 to about 50, or from about 3 to about 45, or from about 5 to about 40. These SHF values apply to the Hencky strain rate between 10 s⁻¹ and 0.1 s⁻¹. The extensional viscosity is measured at 180° C.

The term “strain hardening distribution factor” (or “SHDF”), as used herein, is the slope of the linear regression fit of the strain hardening factor as a function of the logarithm to the basis 10 of the Hencky strain rates between 10 s⁻¹ and 0.1 s⁻¹. The present polymeric composition has a SHDF less than 0 (zero). In other words, the slope of the linear regression fit of the strain hardening factor to the aforementioned log of Hencky strain rate range as herein described is negative.

The SHDF and SHF values for the polymeric compositions are the result of unique long chain branching (LCB) that is present in the propylene-based polymer. A long chain branching index, g′_{lcb}, may be used to determine the degree of long chain branching present in the polymer composition. Lower values for g′_{lcb} indicate relatively higher amounts of branching. In other words, if the g′_{lcb} value decreases, the long chain branching of the polymer increases.

It is understood that short chain branching does not contribute to the strain hardening. Strain hardening requires polymer chain entanglement—a phenomenon of LCB. Chain entanglement is not possible with short chain branching.

The “long chain branching index,” “g′_{lcb},” is defined by the following equation (II):

$${{g}_{lcb}^{′} = \frac{{IV}_{Br}}{{IV}_{Lin}} \vert}_{{M}_{w}} \qquad ( II )$$

wherein IV_{Br} is the intrinsic viscosity of the branched thermoplastic polymer (e.g., propylene-based polymer) as measured at each elution volume by Triple Detector Gel Permeation Chromatography (GPC). Triple Detector GPC (TD-GPC) (as disclosed in Macromolecules, 2000, 33, 7489-7499 and J. Appl Polym. Sci., 29, 3763-3782 (1984)) uses a 20 micron column and 150° C. temperature for polypropylene (versus a 10 micron column and 145° C. temperature for polyethylene) and in accordance with the GPC analytical method disclosed herein. TD-GPC is used to quantify the degree of long chain branching in a selected thermoplastic polymer.

The term IV_{Lin} is the intrinsic viscosity of the corresponding linear thermoplastic polymer (e.g., propylene-based polymer) as measured at each elution volume by Triple Detector GPC and having substantially the same type and distribution of comonomer units as the branched thermoplastic polymer. As used herein, the term “M_{w}”, is the molecular weight measured by light scattering detector at each elution volume and indicates that the ratio is taken for samples of the same M_{w}. In the present disclosure, grafted propylene-based polymer before coupling is used as the linear thermoplastic polymer.

The weight averaged g′_{lcb} is the weight averaged long chain branching index for the molecular weight range and is specified in equation (III):

$$weight averaged {g}_{lcb}^{′} = \frac{{\sum }_{Low Limit of Mw specified}^{High Limit of Mw specified} {w}_{i} * {g}_{lcb}^{′} ( i )}{{\sum }_{Low Limit of Mw specified}^{High Limit of Mw specified} {w}_{i}} \qquad ( III )$$

wherein wᵢ is the weight fraction at M_{w(i)} in the specified M_{w} range and g_{lcb}′(i) is the LCB index at M_{w(i)}.

In an embodiment, the polymer composition has a weight averaged g′_{lcb} for M_{w} from about 150,000 to about 1,000,000 that is less than 0.99, or from about 0.4 to less than 0.99. A long chain branching index g′_{lcb} within this range advantageously provides a propylene-based polymer with beneficial characteristics such as improved processability and increased melt strength.

In an embodiment, the propylene-based polymer has at least two different long chain branched components—a high molecular weight (HMW) component and a low molecular weight (LMW) component. The HMW component has an M_{w} greater than about 500,000, or greater than about 500,000 to about 1,000,000. The LMW component has an M_{w} less than or equal to about 500,000. The long chain branching index may be the same or different for the HMW component and the LMW component.

In an embodiment, the HMW component has an M_{w} greater than about 500,000. The HMW g′_{lcb} at an M_{w} of 1,000,000 is less than 0.99, or from about 0.01 to less than 0.99, or from about 0.40 to about 0.85.

In an embodiment, the LMW component has an M_{w} of less than or equal to about 500,000. The LMW g′_{lcb} at an M_{w} of 500,000 is less than 0.99, or from about 0.01 to less than 0.99, or from about 0.6 to about 0.95.

In an embodiment, the HMW component has a higher (or greater) amount of long chain branching than the LMW component. In other words, the HMW g′_{lcb} value is less than the LMW g′_{lcb} value. The HMW g′_{lcb} value may be from about 0.7 to about 0.92 and the LMW g′_{lcb} value may be from about 0.8 to about 0.95, the HMW g′_{lcb} being less than the LMW g′_{lcb} value.

The negative slope for the SHDF indicates that the present polymer composition has higher long chain branching in the HMW component than in the LMW component. Not bound by any particular theory, it is believed that if a material does not show strain hardening, its extensional viscosity should be equal to three times its shear viscosity at the same measurement time and at the same temperature, i.e. SHF should equal one (SHF=1). Any positive deviation from the value of 1 indicates the material shows strain hardening. For polyolefins (such as polyethylene and/or polypropylene) having a linear or a single branched (Y-shaped) polymer chain structure, strain hardening is not expected within the Hencky strain rates from 10 s⁻¹ to 0.1 s⁻¹. Multi-branched molecules, however, can show strain hardening. The extent of the strain hardening can be described by the magnitude or degree of deviation between a material's extensional viscosity data and its shear viscosity data. One way to measure the extent of the strain hardening is to use the SHF values in which extensional viscosity is compared with shear viscosity at the same measurement time. A larger SHF value indicates greater or stronger strain hardening. The extent of the strain hardening is also related to the level of the LCB in the molecules. The stronger the strain hardening, the higher the LCB level is in the molecules.

The distribution of the strain hardening across the Hencky strain rates can also indicate the distribution of the LCB in the molecules. Lower Hencky strain rate data correlates to the HMW components. High Hencky strain rates correlates to the LMW components. Therefore, a negative strain hardening distribution factor (SHDF) indicates strain hardening is stronger at low Hencky strain rates than at the high Hencky strain rates (i.e., a higher degree of LCB in the HMW component than in the LMW component). In other words, the LCB level is higher at the high end of the molecular weight distribution (MWD) than at the lower end. This is apparent by the Mark-Houwink plot at FIG. 3.

The term “propylene-based polymer,” as used herein is a polymer that comprises a majority weight percent polymerized propylene monomer (based on the total amount of polymerizable monomers), and optionally may comprise at least one polymerized comonomer. The propylene-based polymer may be a propylene homopolymer (i.e., a polypropylene) or a propylene copolymer. The propylene copolymer may be a propylene/olefin copolymer, for example. Nonlimiting examples of suitable olefin comonomers include ethylene, C₄₋₂₀ α-olefins, C₄₋₂₀ diolefins, and non-halogenated or halogenated C₈₋₄₀ vinyl aromatic compounds including styrene, o-, m-, and p-methylstyrene, divinylbenzene, vinylbiphenyl, vinylnapthalene.

The propylene-based polymer may be selected from a propylene homopolymer, a propylene/olefin copolymer (random or block), and/or a propylene impact copolymer. The propylene-based polymer may be a reactor polymer or a post-reactor polymer. Any of the foregoing propylene-based polymers may be nucleated or may be non-nucleated. In an embodiment, the propylene-based polymer is a propylene-ethylene copolymer. In another embodiment, the propylene-based polymer is a propylene homopolymer such as a polypropylene.

The propylene-based polymer may be a Ziegler-Natta catalyzed propylene-based polymer, a single-site catalyzed propylene-based polymer (i.e., a metallocene catalyst and/or a constrained geometry catalyst as disclosed in U.S. Pat. No. 5,783,638), or a nonmetallocene, metal-centered, heteroaryl ligand catalyzed propylene-based polymer as disclosed in U.S. Pat. No. 6,906,160.

In an embodiment, the propylene-based polymer may be a nitrene-coupled polypropylene. A “nitrene-coupled polypropylene,” as used herein, is a polypropylene with one or more nitrene groups linking two or more polymer chains. In an embodiment, the nitrene-coupled polypropylene is a reaction product of polypropylene and an azide such as a phosphazene azide, a sulfonyl azide, and/or a formyl azide.

In an embodiment, polymer composition includes a propylene-based polymer with a molecular weight distribution (MWD) from about 3.0 to about 15.0, or from about 4.0 to 10.0, or from about 5.0 to 9.0.

In an embodiment, the polymer composition has a gel content less than about 10 wt %, or from about 0 wt % to about 10 wt %, or from about 0.1 wt % to about 5 wt %, or from about 0.5 wt % to about 3 wt %. Weight percent is based on the total weight of the propylene-based polymer. In a further embodiment, the propylene-based polymer may be substantially gel-free or gel-free. As used herein, “substantially gel-free” is a percent gel content that is less than about than about 5 wt %, or less than about 3%, or less than about 2%, or less than about 0.5%. The term “gel-free” is a gel content below detectable limits when using xylene as the solvent. Gel content is determined in accordance with ASTM D2765-01 Method A in xylene.

In an embodiment, the polymer composition has a melt flow rate (MFR) from about 0.05 g/10 min to about 100 g/10 min, or from about 0.5 g/10 min to about 15 g/10 min as measured in accordance with ASTM D 1238-01 230° C., 2.16 kg.

In an embodiment, the polymer composition includes a propylene-based polymer that is a silane-coupled propylene-based polymer. As used herein, “silane coupling” or “silane-coupled” is the formation of a chemical bond between two or more of the molecular chains of the propylene-based polymer by way of a silane linkage. A “silane linkage” has the structure —Si—O—Si—. Each silane linkage may connect two or more, or three or more, molecular chains of propylene-based polymer. The propylene-based polymer that is silane coupled may be any propylene-based polymer as disclosed herein.

In an embodiment, a process is provided to produce the polymer composition. The process includes moisture curing a silane-grafted propylene-based polymer in the presence of a moisture-curing catalyst. The process further includes forming a silane-coupled propylene-based polymer having a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹ as disclosed above.

In an embodiment, the process includes forming a silane-coupled propylene-based polymer that is substantially gel-free. In another embodiment, the process includes forming a silane-coupled propylene-based polymer that is gel-free.

Any silane that will effectively graft to a propylene-based polymer, can be used. In an embodiment, the silane is a vinyl functional silane compound. The vinyl functional silane compound is represented by the formula (IV):

RR′SiY₂ (IV)

wherein R is a monovalent olefinic unsaturated hydrocarbon group or a substituted hydrocarbon group, Y is a hydrolysable organic group, and R′ is a monovalent hydrocarbon group or a substituted hydrocarbon group other than aliphatic unsaturated hydrocarbons or is identical with Y. Not wishing to be bound by any particular theory, it is believed that the vinyl functional silane compound creates a coupling point among the propylene-based polymer molecular chains. Nonlimiting examples of suitable vinyl functional silanes include unsaturated silanes that comprise an ethylenically unsaturated hydrocarbyl group, such as a vinyl, allyl, isopropenyl, butenyl, cyclohexenyl or γ-(meth)acryloxyalkyl group. Nonlimiting examples of suitable hydrolysable groups include hydrocarbyloxy groups, and hydrocarbylamino groups. Nonlimiting examples of other hydrolysable groups include methoxy, ethoxy, formyloxy, acetoxy, proprionyloxy, and alkyl or arylamino groups. The amount of vinyl functional silane compound added is from about 0.1 wt % to about 5.0 wt %, or from about 0.5 wt % to about 3.0 wt %, or from about 0.7 wt % to about 2.0 wt %. Weight percent is based on the total weight of the propylene-based polymer.

In an embodiment, the vinyl functional silane compound is an unsaturated alkoxysilane. Nonlimiting examples of suitable unsaturated alkoxysilanes includes vinyl trimethoxysilane, vinyl triethoxysilane, vinyl tributoxysilane, γ-(meth)acryloxy propyl trimethoxysilane, allyl trimethoxysilane allyl triethoxysilane, and any combination thereof. In an embodiment, the vinyl functional silane compound is vinyl trimethoxysilane and/or vinyl triethoxysilane.

In an embodiment, the process includes grafting the silane to a propylene-based polymer by way of free radical functionalization. Free radical functionalization includes melt blending a propylene-based polymer, a free radical initiator (such as a peroxide, an azo compound, or the like), and a functional coagent e.g., a silane. As used herein, “melt blending” is a process in which a polymer is softened and/or melted and mixed with one or more other compounds. Nonlimiting examples of melt blending processes include extrusion, melt mixing (batch or continuous), reactive melt blending, and/or compounding. In one embodiment, melt blending occurs in a Buss kneader at a temperature between 150° C. and 300° C., or between 190° C. and 230° C. (depending upon the residence time and the half life of the initiator).

During melt blending, the free radical initiator reacts (reactive melt blending) with the propylene-based polymer to form polymer radicals. The silane bonds to the backbone of the polymer radicals to form the silane-grafted propylene-based polymer.

Nonlimiting examples of suitable free radical initiators include azo compounds and peroxides such as dicumyl peroxide, di-tert-butyl peroxide, tert-butyl perbenzoate, benzoyl peroxide, cumene hydroperoxide, tert-butyl peroctoate, methyl ethyl ketone peroxide, 2,5-dimethyl-2,5-di(tert-butyl peroxy)hexane, lauryl peroxide, and tert-butyl peracetate. A suitable azo compound is 2,2′-azobis(isobutyronitrile). The amount of initiator can vary, but it is typically present in an amount from about 100 ppm to about 1000 ppm; or from about 200 ppm to about 800 ppm. The amount of silane is from about 0.1 wt % to about 10 wt %, or from about 0.3 wt % to about 7 wt %. In an embodiment, the maximum amount of silane does not exceed 6 wt %. The ratio of silane to initiator may be between 10:1 to 100:1, or between 20:1 to 70:1.

The term “melt processing,” as used herein, is a process whereby a polymer is softened or melted and subsequently manipulated. Nonlimiting examples of melt processes include extruding, pelletizing, molding, blowmolding, thermoforming, film blowing, fiber spinning, and the like. It is understood that melt blending and melt processing may occur simultaneously or sequentially.

In an embodiment, the grafting reaction occurs at reaction a temperature from about 150° C. to about 300° C., or from about 170° C. to about 280° C. The grafting reaction can be carried out in the presence of typical antioxidants, acid scavengers, heat and light stabilizers, pigments, etc.

The present process includes moisture curing the silane-grafted propylene-based polymer to couple the silane-grafted propylene-based polymer. As used herein, “moisture curing” is the hydrolysis of hydrolysable groups by exposure of the silane-grafted propylene-based polymer to water (and optionally a moisture curing catalyst), yielding silanol groups which then undergo condensation to form silane linkages. The silane linkages couple polymer chains to produce the silane-coupled propylene-based polymer. A schematic representation of the moisture curing reaction is provided in reaction (V) below.

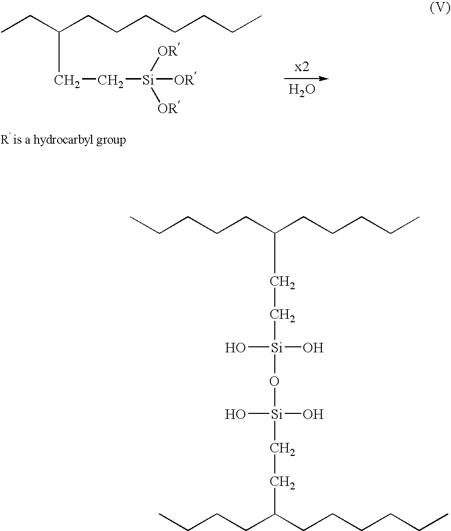

In an embodiment, the moisture is water. In another embodiment, the moisture may be generated from a moisture-generating component. A “moisture-generating component,” as used herein, is a composition that decomposes at a melt-blend temperature to produce water. A nonlimiting example of a moisture-generating component is aluminum trihydroxide (ATH). Silane grafting and moisture curing may occur sequentially or simultaneously. In a further embodiment, exposing the silane-grafted polymer to moisture occurs by immersing the silane-grafted propylene-based polymer in a water bath (heated or unheated).

In an embodiment, the moisture curing occurs in the presence of a moisture-curing catalyst. Provision of a moisture-curing catalyst during moisture cure promotes the moisture curing reaction and the formation of silane linkages in particular. The moisture-curing catalyst may be selected from organic bases; carboxylic acids; sulfonic acids; organometallic compounds including organic titanates and complexes or carboxylates of lead, cobalt, iron, nickel, zinc, zirconium and tin; or any combination of the foregoing. The moisture-curing catalyst (or mixture of catalysts) may be present in a catalytic amount, from about 50 ppm to about 10,000 ppm, or from about 100 ppm to about 5000 ppm.

In an embodiment, the moisture-curing catalyst is a sulfonic acid. Nonlimiting examples of suitable sulfonic acids include sulfonic acids of the formula (VI):

R₁ArSO₃H (VI)

wherein R₁ is hydrogen or a hydrocarbyl group containing 1 to 20 carbon atoms. The term “Ar” is an aryl group. The aryl group may be benzene or naphthalene. As used herein, the term “hydrocarbyl” and “hydrocarbon” refer to substituents containing only hydrogen and carbon atoms, including branched or unbranched, saturated or unsaturated, cyclic, polycyclic or noncyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, I, Br), N, O, P, B, S, Si, Sb, Al, Sn, As, Se and Ge. As used herein, the term “halohydrocarbyl” refers to a hydrocarbyl that is substituted with one or more halogen atoms.

Nonlimiting examples of suitable sulfonic acids include dodecylbenzene sulfonic acid and tetrapropylbenzene sulfonic acid, and combinations thereof. In a further embodiment, the sulfonic acid is dodecylbenzene sulfonic acid.

In an embodiment, the moisture-curing catalyst may be an organometallic compound. Nonlimiting examples of suitable organometallic compounds include dibutyltin dilaurate, dioctyltin maleate, dibutyltin diacetate, dibutyltin dioctoate, dibutyltin oxide, butyl stannoic acid, dioctyltin dilaurate, dioctyltin maleate, butyltin tris(2-ethylhexoate), hydrated monobutyltin oxide, stannous acetate, stannous octoate, lead naphthenate, zinc caprylate, cobalt naphthenate; and the like.

In an embodiment, production of the silane-coupled propylene-based polymer occurs by way of in situ moisture curing. As used herein, “in-situ moisture curing” refers to melt blending the silane-grafted propylene-based polymer with water and/or a moisture-generating component to couple chains of the propylene-based polymer by way of silane linkages. In a further embodiment, the in situ moisture curing is performed in an extruder.

In an embodiment, the in situ moisture cure occurs in an extruder at a temperature from about 150° C. to about 300° C., or from about 170° C. to about 280° C. The extruder may have a plurality of zones. The temperature length, and/or screw configuration of each zone may be the same or different.

The moisture curing of the silane grafted propylene-based polymer may be performed in the same or different equipment used for the grafting reaction. The disclosure above regarding the silane grafting reaction may also apply to the moisture curing reaction. In an embodiment, a propylene-based polymer, a silane, a peroxide, and a moisture-generating component are melt blended in an extruder. The melt blending results in a silane-grafted propylene-based polymer which undergoes in situ moisture curing. The moisture generating component is added in a sufficient amount to generate at least about 5 moles of water for each mole of silane grafted to the propylene-based polymer. The in-situ moisture generation couples the propylene-based polymer to produce a silane-coupled propylene-based polymer.

In an embodiment, the in situ moisture cure is performed in an extruder. A propylene-based polymer having a MFR from about 0.5 g/10 min to about 10 g/10 min, or from about 1.0 g/10 min to about 5.0 g/10 min is heated to a temperature above its melting point. An initiator (such as a peroxide) is subsequently melt blended with the propylene-based polymer. A silane is melt blended with the propylene-based polymer simultaneously with, or sequentially to, the initiator. Reactive melt blending continues to form a silane-grafted propylene-based polymer having an MFR from about 20 g/10 min to about 60 g/10 min, or from about 30 g/10 min to about 50 g/10 min.

The silane-grafted propylene-based polymer proceeds through the extruder where water and/or a moisture-generating component is/are added to the silane-grafted propylene-based polymer. A moisture curing catalyst such as a sulfonic acid is also added to the extruder. In an embodiment, the moisture-curing catalyst is dodecylbenzene sulfonic acid (DDBSA). The moisture cure results in the formation of a silane-coupled propylene-based polymer in the extruder. The moisture-cured silane-coupled propylene-based polymer composition subsequently exits the extruder. Curing may or may not continue upon exit of the silane-coupled propylene-based polymer composition from the extruder.

In an embodiment, the in situ moisture cure is performed in an extruder with at least a first zone and a second zone. Reactive melt blending of the propylene-based polymer, initiator, and silane may occur in the first zone. Water and/or the moisture-generating component, and the moisture-curing catalyst may be added to the silane-grafted propylene-based polymer in the second zone. It is understood that the first zone may or may not be directly adjacent to the second zone.

In an embodiment, the process includes curing the silane-coupled propylene-based polymer to a MFR from about 0.05 g/10 min to about 15 g/10 min, or from about 1 g/10 min to about 10 g/10 min, within less than about 28 days, or less than 21 days, or less than 14 days, from the moisture cure. The cure occurs at ambient temperature (7° C.-32° C.) and ambient relative humidity. Applicants have surprisingly and unexpectedly discovered that the present process significantly reduces the time required to cure the silane-coupled propylene-based polymer to a low MFR when compared to moisture curing procedures utilizing a metal-based moisture-curing catalyst, for example. In particular, the present process cures a high MFR silane-grafted propylene-based polymer (MFR 20-60 g/10 min) to a silane-coupled propylene-based polymer with a low MFR (0.05-5 g/10 min) in less than about 28 days. Silane-grafted propylene-based polymers moisture cured by way of a metal-based moisture-curing catalyst (at ambient temperature and ambient relative humidity) typically require 6-12 weeks to cure to a MFR of 1.0 g/10 min to 10.0 g/10 min. The present process, however, cures the silane-coupled propylene-based polymer in less than about 28 days—decreasing production time and reducing storage and curing costs.

Applicants have further surprisingly and unexpectedly discovered that in situ moisture cure of a silane-grafted propylene-based polymer with a sulfonic acid produces a silane-coupled propylene-based polymer with unique long chain branching and no, or substantially no, gel content. This unique long chain branching yields the SHDF and/or the SHF values as previously disclosed herein.

In an embodiment, the process includes forming a silane-coupled propylene-based polymer composition having a silicon content from about 0.02% wt % to about 2.0 wt %, or from about 0.1 wt % to about 1.5 wt %, or from about 0.15 wt % to about 1.0 wt %. Weight percent is based on the total weight of the silane-coupled propylene-based polymer.

In an embodiment, the process includes forming a silane-coupled propylene-based polymer composition having from about 60 wt % to about 99.5 wt %, or from about 75 wt % to about 99 wt % units derived from propylene. Weight percent is based on the total weight of the polymer composition.

In an embodiment, the process includes forming a silane-coupled propylene-based polymer composition having from about 0.025 wt % to about 1.0 wt %, or from about 0.05 wt % to about 0.75 wt % of a sulfonic acid. In an embodiment, the sulfonic acid is DDBSA.

The polymer composition containing the silane-coupled propylene-based polymer may have any of the properties (SHF and/or SHDF) as disclosed for the polymer composition. In an embodiment, the silane-coupled propylene-based polymer has a SHDF less than 0. In another embodiment, the silane-coupled propylene-based polymer formed by way of the present process has a strain hardening factor of at least 1.5.

In an embodiment, the silane coupling between multiple polymer chains produces long chain branching within the silane-coupled propylene-based polymer. The polymer composition including silane-coupled propylene-based polymer may exhibit any of the long chain branching characteristics (g′_{lcb}) as disclosed herein.

The polymer composition containing the silane-coupled propylene-based polymer may have one or more of the following properties (and ranges/sub-ranges): no, or substantially no, gel content; a MFR from about 0.05 g/min to about 100 g/min; and a MWD from about 3.0 to about 15.0.

The present process may comprise two or more embodiments disclosed herein.

The polymer composition may comprise two or more embodiments disclosed herein.

In an embodiment, the silane-coupled propylene-based polymer may be compounded (or blended, or melt-blended) with one or more of the following to form the polymer composition: propylene homopolymer, propylene random copolymer, propylene impact copolymer, and any combination thereof.

The present polymer composition may be used to form a foam composition. In an embodiment, a foam composition is provided which includes a propylene-based polymer having a strain hardening distribution factor (SHDF) less than 0. The foam composition has a density from about 5 kg/m³ to about 850 kg/m³.

The foam composition may include any polymer composition disclosed herein. In an embodiment, the foam composition includes a silane-coupled propylene-based polymer. The foam composition may have a silicon content from about 0.02 wt % to about 2.0 wt %. Weight percent silicon is based on the total weight of the foam.

In an embodiment, the foam composition includes from about 60 wt % to about 99.5 wt %, or from about 75 wt % to about 99 wt % units derived from propylene. Weight percent units derived from propylene is based on the total weight of the foam composition.

In an embodiment, the foam composition includes from about 0.025 wt % to about 1.0 wt %, or from about 0.05 wt % to about 0.75 wt % of a sulfonic acid. In an embodiment, the sulfonic acid is DDBSA.

Production of the foam composition may occur sequentially or simultaneously with the silane grafting and/or the moisture curing. For example, a blowing agent (inorganic, organic, and/or chemical) and optionally a nucleating agent may be added to the extruder in which silane grafting and/or in situ moisture curing is performed. Various additives may be incorporated in the present foam composition such as inorganic fillers, pigments, antioxidants, acid scavengers, ultraviolet absorbers, flame retardants, processing aids, extrusion aids, permeability modifiers, antistatic agents, other thermoplastic polymers and the like.

Nonlimiting examples of suitable processes by which the present foam may be formed include a coalesced strand extrusion process, an accumulating extrusion process, and/or a foam bead forming process suitable for molding the beads into articles by expansion or pre-expansion of the beads. In an embodiment, the foam composition is prepared by melt blending in which the propylene-based polymer is heated to form a plasticized or melt polymer material, incorporating therein a blowing agent to form a foamable polymer, and extruding the polymer through a die to form the foam composition.

The present foam composition may be used to make foamed films for bottle labels and other containers using either a blown film or a cast film extrusion process. The films may also be made by a co-extrusion process to obtain foam in the core with one or two surface layers, which may or may not be comprised of the polymer compositions disclosed herein.

The present foam composition has a density from about 5 kg/m³ to about 850 kg/m³. Density is measured in accordance with ASTM D-1622-88.

In an embodiment, the foam composition has an average cell size from about 0.01 mm to about 10 mm, or from about 0.1 mm to about 4.0 mm, or from about 0.2 mm to about 1.8 mm. Average cell size is determined in accordance with ASTM D3576-77.

The present foam composition may be formed into a plank or a sheet, such as one having a thickness or minor dimension in cross-section of 1 mm or more, or 2 mm or more, or 2.5 mm or more, or from about 1 mm to about 200 mm. The foam width may be as large as about 1.5 meter.

In an embodiment, the foam composition has a melt flow rate from about 0.3 g/10 min to about 15 g/10 min, or from about 0.5 g/10 min to less than 10 g/10 min.

In an embodiment, the present foam composition has an open cell content ranging from 0% to about 70%, or from about 5% to about 50%. Open cell content is determined in accordance with ASTM D2856-94.

In an embodiment, the foam composition is gel-free, or substantially gel-free.

The foam composition may comprise two or more embodiments disclosed herein.

The present foam composition may be used in a variety of applications. Nonlimiting examples of such applications include cushion packaging, athletic and recreational products, egg cartons, meat trays, building and construction (e.g., thermal insulation, acoustical insulation), pipe insulation, gaskets, vibration pads, luggage liners, desk pads shoe soles, gymnastic mats, insulation blankets for greenhouses, case inserts, display foams, etc. Nonlimiting examples of building and construction applications include external wall sheathing (home thermal insulation), roofing, foundation insulation, and residing underlayment. Other nonlimiting applications include insulation for refrigeration, buoyancy applications (e.g., body boards, floating docks and rafts) as well as various floral and craft applications. It should be clear, however, that the foams of this disclosure will not be limited to the above mentioned applications.

Nonlimiting embodiments of the polymer composition, the process for producing the polymer composition, and the foam composition are provided below.

In an embodiment, a polymer composition is provided which comprises a propylene-based polymer having a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹.

In an embodiment, the polymer composition has a strain hardening factor (SHF) greater than 1.5 at Hencky strain rates between 10 s⁻¹ and 0.1 s⁻¹ at 180° C. The SHF is the ratio of the extensional viscosity to three times of the shear viscosity at the same measurement time and at the same temperature.

In an embodiment, the polymer composition has a weight averaged long chain branching index g′_{lcb} less than 0.99 for M_{w} from about 150,000 to about 1,000,000.

In an embodiment, the propylene-based polymer of the polymer composition comprises a high molecular weight (HMW) component and a low molecular weight (LMW) component. The HMW component comprises a higher level of long chain branching than the LMW component.

In an embodiment, the polymer composition is substantially gel-free.

In an embodiment, the propylene-based polymer of the polymer composition is selected from the group consisting of a propylene homopolymer and a propylene/olefin copolymer.

In an embodiment, the propylene-based polymer of the polymer composition is selected from the group consisting of a Ziegler-Natta catalyzed propylene-based polymer, a metallocene-catalyzed propylene-based polymer, a nitrene-coupled polypropylene, a constrained geometry catalyzed propylene-based polymer, a nonmetallocene metal-centered, aryl or heteroaryl ligand catalyzed propylene copolymer, and combinations thereof.

In an embodiment, the polymer composition comprises a silane-coupled propylene-based polymer.

In an embodiment, the polymer composition comprises a silicon content from about 0.02 wt % to about 2.0 wt %.

In an embodiment, the polymer composition has a melt flow rate from about 0.05 g/10 min to about 100 g/10 min as measured in accordance with ASTM D 1238-01 230° C., 2.16 kg.

In an embodiment, the polymer composition has a molecular weight distribution from about 3.0 to about 15.0.

In an embodiment, the polymer composition comprises from about 0.025 wt % to about 1.0 wt % of a sulfonic acid.

In an embodiment, the polymer composition comprises from about 60 wt % to about 99.5 wt % of units derived from propylene.

The present disclosure provides a process. In an embodiment, a process for producing a polymer composition is provided which includes moisture curing a silane-grafted propylene-based polymer in the presence of a sulfonic acid, and forming a silane-coupled propylene-based polymer having a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹.

In an embodiment, the process comprises forming a silane-coupled propylene-based polymer that is substantially gel-free.

In an embodiment, the process comprises in situ moisture curing the silane-grafted propylene-based polymer.

In an embodiment, the process comprises forming, before the moisture-curing, a silane-grafted propylene-based polymer having a melt flow rate from about 20 g/10 min to about 60 g/10 min as measured in accordance with ASTM D1238-01 230°, 2.16 kg.

In an embodiment, the process comprises curing, at ambient temperature and relative humidity, the silane-coupled propylene-based polymer to a melt flow rate from about 0.05 g/10 min to about 15 g/10 min within less than about 28 days from the moisture curing.

The present disclosure provides a foam composition. In an embodiment, a foam composition is provided which comprises a propylene-based polymer having a strain hardening distribution factor (SHDF) less than 0. The SHDF is the slope of the linear regression fit of the strain hardening factor as a function of the logarithm to the basis 10 of the Hencky strain rates between 10 s⁻¹ and 0.1 s⁻¹. The foam composition having a density from about 5 kg/m³ to about 850 kg/m³.

In an embodiment, the foam composition has a thickness of from about 1 mm to about 200 mm.

In an embodiment, the foam composition comprises an average cell size from about 0.01 mm to about 10 mm as measured in accordance with ASTM D3576-77.

In an embodiment, the propylene-based polymer of the foam composition comprises long chain branching.

In an embodiment, the foam composition comprises a silane-coupled propylene-based polymer.

In an embodiment, the foam composition comprises a silicon content from about 0.02 wt % to about 2.0 wt %.

In an embodiment, the foam composition comprises from about 0.025 wt % to about 1.0 wt % of a sulfonic acid.

In an embodiment, the foam composition comprises from about 60 wt % to about 99.5 wt % of units derived from propylene.

### DEFINITIONS

Any numerical range recited herein, includes all values from the lower value and the upper value, in increments of one unit, provided that there is a separation of at least two units between any lower value and any higher value. As an example, if it is stated that a compositional, physical or other property, such as, for example, molecular weight, melt index, etc., is from 100 to 1,000, it is intended that all individual values, such as 100, 101, 102, etc., and sub ranges, such as 100 to 144, 155 to 170, 197 to 200, etc., are expressly enumerated in this specification. For ranges containing values which are less than one, or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this application. In other words, any numerical range recited herein includes any value or subrange within the stated range. Numerical ranges have been recited, as discussed herein, in reference to density, weight percent of component, molecular weights and other properties.

All references to the Periodic Table of the Elements herein shall refer to the Periodic Table of the Elements, published and copyrighted by CRC Press, Inc., 2003. Also, any references to a Group or Groups shall be to the Groups or Groups reflected in this Periodic Table of the Elements using the IUPAC system for numbering groups. Unless stated to the contrary, implicit from the context, or customary in the art, all parts and percents are based on weight. For purposes of United States patent practice, the contents of any patent, patent application, or publication referenced herein are hereby incorporated by reference in their entirety (or the equivalent US version thereof is so incorporated by reference), especially with respect to the disclosure of synthetic techniques, definitions (to the extent not inconsistent with any definitions provided herein) and general knowledge in the art.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

The term “composition,” as used herein, includes a mixture of materials which comprise the composition, as well as reaction products and decomposition products formed from the materials of the composition.

The term “polymer” is a macromolecular compound prepared by reacting (i.e., polymerization) monomers of the same or different type. “Polymer” includes homopolymers and interpolymers.

The term “interpolymer,” is a polymer prepared by the polymerization of at least two different types of monomers. The generic term interpolymer thus includes copolymers, usually employed to refer to polymers prepared from two different monomers, and polymers prepared from more than two different types of monomers.

The term “olefin-based polymer” is a polymer containing, in polymerized form, a majority weight percent of an olefin, for example ethylene or propylene, based on the total weight of the polymer. Nonlimiting examples of olefin-based polymers include ethylene-based polymers and propylene-based polymers.

### Test Methods

Extensional Viscosity—is measured by an extensional viscosity fixture (EVF) of TA Instruments (New Castle, Del.) attached onto an ARES rheometer of TA Instruments at Hencky strain rates of 10 s⁻¹, 1 s⁻¹ and 0.1 s⁻¹ at 180° C. Extensional viscosity is measured in Pascal multiple seconds, or Pa·s.

A. Sample Preparation for Extensional Viscosity Measurement

A sample plaque is prepared on a programmable Tetrahedron bench top press. The program holds the melt at 180° C. for 5 minutes at a pressure of 10⁷ Pa. The Teflon® coated chase is then removed to the benchtop to cool. Test specimens are then die-cut from the plaque using a punch press and a handheld die with the dimensions of 10×18 mm² (Width×Length). The specimen thickness is in the range of about 0.7 mm to about 1.1 mm.

B. Extensional Viscosity Measurement

The rheometer oven that encloses the EVF fixture is set to test temperature of 180° C. for at least 60 minutes prior to zeroing fixtures. The width and the thickness of each film is measured at three different locations of the film and the average values are entered into the test program (TA Orchestrator version 7.2). Densities of the sample at room temperature (0.9 g/cm³) and at the test temperature (0.767 g/cm³ at 180° C.) are also entered into the test program to allow for the program to calculate the actual dimensions of the film at test temperature. The film specimen is attached onto each of the two drums of the fixture by a pin. The oven is then closed to let temperature equilibrate before starting test. The test is divided into three zones. The first zone is the pre-stretch zone that stretches the film at a very low strain rate of 0.005 s⁻¹ for 11 seconds. The purpose of this step is to reduce film buckling introduced when the film is loaded as well as to compensate the thermal expansion of the sample when it is heated above room temperature. This is followed by a relaxation zone of 60 seconds to minimize the stress introduced in the pre-stretch step. The third zone is the measurement zone where the film is stretched at the pre-set Hencky strain rate. The data collected in the third zone is used for analysis.

Gel Content—is determined in accordance with ASTM D2765-01 Method A in xylene. The sample is cut into required size by using razor.

Gel Permeation Chromatography (GPC) Analytical Method—Polymers are analyzed by triple detector gel permeation chromatography (GPC) on a Polymer Laboratories PL-GPC-200 series high temperature unit equipped with refractometer detector, light scattering and online viscometer. Four PLgel Mixed A (20 μm) are used. The oven temperature is at 150° C. with the autosampler hot and the warm zone at 130° C. The solvent is nitrogen purged 1,2,4-trichlorobenzene (TCB) containing 180 ppm 2,6-di-t-butyl-4-methylphenol (BHT). The flow rate is 1.0 ml/min and the injection size is 200 μl. A 2 mg/ml sample concentration is prepared by dissolving the sample in preheated TCB containing 180 ppm BHT for 2.5 hrs at 160° C. with gentle agitation. One or two injections per sample are performed.

The molecular weight determination (MWD) is deduced by using 21 narrow molecular weight distribution polystyrene standards ranging from Mp 580-8,400,000 (Polymer Laboratories). The equivalent polypropylene molecular weights by conventional GPC are calculated by using appropriate Mark-Houwink coefficients for polypropylene. The polydispersity (PDI) is defined as the ratio of weight averaged molecular weight versus number averaged molecular weight by conventional GPC.

| | Mha | MHk |
|---|---|---|
| Polypropylene | 0.725 | −3.721 |
| Polystyrene | 0.702 | −3.900 |

Melt Flow Rate (MFR)—is measured in accordance with ASTM D 1238-01 test method at 230° C. with a 2.16 kg weight for propylene-based polymers.

Shear Viscosity—Shear viscosity is obtained from dynamic mechanical oscillatory shear measurements.

A. Sample Preparation for Dynamic Mechanical Oscillatory Shear Measurement

Specimens for dynamic mechanical oscillatory shear measurements are prepared on a programmable Tetrahedron bench top press. The program holds the melt at 180° C. for 5 minutes at a pressure of 10⁷ Pa. The chase is then removed to the benchtop to cool down to room temperature. Round test specimens are then die-cut from the plaque using a punch press and a handheld die with a diameter of 25 mm. The specimen is about 3.5 mm thick.

B. Dynamic Mechanical Oscillatory Shear Measurement

Shear viscosity is obtained from dynamic mechanical oscillatory shear measurements. Dynamic mechanical oscillatory shear measurements are performed with the ARES rheometer at 180° C. using 25 mm parallel plates at a gap of 2.0 mm with a strain of 10% under an inert nitrogen atmosphere. The frequency interval is from 0.1 to 100 radians/second. Shear viscosity data is converted to a function of time by taking the reciprocal of the angular frequency. A 4^{th}-order polynomial fit is applied to the viscosity-time curve to extend the measurement time to 40 seconds, so that the SHF at 0.1 s⁻¹ Hencky strain rate can be calculated.

This is performed prior to calculating SHF.

By way of example and not by limitation, examples of the present disclosure will now be provided.

### Examples

Table 1 below provides the materials used in Examples 1-4.

TABLE 1

| Material (abbrev) | Source |
|---|---|
| Polypropylene (PP) | D207.02 developmental performance polymer The |
| (nucleated, MFR 1.8 g/10 min) | Dow Chemical Company |
| Vinyltrimethoxysilane (VTMS) | CAS 2768-02-7 Dow Corning |
| 2, 5-Di-tert-butylperoxy-2, 5- | CAS 78-63-7 Aldrich |
| dimethylhexane (Lupersol 101) | |
| Dodecylbenzenesulfonic acid (DDBSA) | CAS 27176-87-0 Aldrich |

Silane is grafted onto the polypropylene using a Werner and Pfleiderer ZSK 30 mm co-rotating intermeshing twin screw extruder. The extruder has eleven barrel zones with a 35:1 L/D. The extruder has 10 temperature control zones including the die. It is water cooled at the feed throat and zones 2-11. The vent port is located at Barrel 9 and has vacuum capability for devolatilization. Vacuum of 27 inches Hg is applied at the vent port. A “K-Tron T-35” screw feeder is used to feed the PP resin into the extruder hopper. A water bath and a strand cutter are used to cut the strands into pellets. A die with one hole is used to make pellets. Air purging is used to dry the pellet samples as they are produced. The processing conditions are maintained at 10 lb/hr rate with a screw speed of 200 rpm for all samples. The melt temperatures at the extruder discharge are checked by a handheld pyrometer and range from 208° C. to 230° C. The foregoing procedure produces a silane-grafted polypropylene (PP-g-VTMS).

Moisture Cure Extrusion

A series of curing runs are conducted on the PP-g-VTMS samples. Water, DDBSA, and a Haake Polylab-driven Leistritz micro-18 twin screw extruder, are used to moisture cure the PP-g-VTMS.

The extruder consists of six 90-mm barrels (zones) and a single-hole (3mm) strand die. The first barrel is open as the feed throat with its jacket cooled with running water to prevent feed bridging. The temperature settings of zones 2-6 are 150° C., 175° C., 190° C., 190° C., and 210° C., respectively. The die temperature is set at 210° C. The screw stack consists of a forwarding heating area, then a series of kneading blocks for shear heating and mixing/reacting, followed by more forwarding and kneading block areas to complete the reaction/curing and pressuring the polymer through the die to a series of quench tanks to cool/solidify the polymer strand. The polymer strand is dried by air knife and chopped into pellets by a strand chopper. The prepared mixtures are fed to the preheated and calibrated extruder from a K-Tron twin auger model K2VT20 feeding hopper. The top of the hopper is covered with a lid equipped with a nitrogen purge line. The feed cone/throat and the discharge of the feeder are covered with heavy aluminum foil to maintain the nitrogen atmosphere through the extruder. The drive unit of the extruder is set at 200 rpm, which is converted by gearbox to a screw speed of 250 rpm.

Table 2 shows properties of the silane-grafted propylene homopolymer and the moisture cured product thereof. The SHF, SHDF, and branching properties for Examples 1-4 are also provided in Table 2.

TABLE 2

| | Example 1 | Example 2 | Example 3 | Example 4 |
|---|---|---|---|---|
| VTMS | 3.5 wt. % | 3.5 wt. % | 5.5 wt. % | 2.5 wt. % |
| Lupersol 101 | 700 ppm | 450 ppm | 700 ppm | 700 ppm |
| DDBSA | 2000 ppm | 2000 ppm | 2000 ppm | 2000 ppm |
| Grafted silane level | 1.14 wt. % | 1.00 wt. % | 1.64 wt. % | 0.91 wt. % |
| MFR (uncured) (g/10 min @ 230° C.) | 47.8 | 27.8 | 50.5 | 43.8 |
| MFR (cured) (g/10 min @ 230° C.) | 6.4 | 7.4 | 1.8 | 13.1 |
| Mw by conventional GPC (g/mol) | 189,910 | 184,640 | 196,760 | 177,460 |
| PDI | 4.2 | 3.7 | 4 | 3.9 |
| g′_{lcb}, at M_{w}, of 500,000 g/mol | 0.864 | 0.892 | 0.831 | 0.875 |
| g′_{lcb}, at M_{w} of 1,000,000 g/mol | 0.731 | 0.820 | 0.666 | 0.776 |
| Weight averaged g′_{lcb}, at M_{w} from 150,000 | 0.914 | 0.931 | 0.890 | 0.920 |
| to 1,000,000 g/mol | | | | |
| Gel content | <5 wt. % | <5 wt. % | <5 wt. % | <5 wt. % |
| SHF at 0.1 s⁻¹ | 11.21 | 5.34 | 39.94 | 5.84 |
| SHF at 1.0 s⁻¹ | 7.36 | 4.35 | 25.00 | 5.40 |
| SHF at 10 s⁻¹ | 4.45 | 2.74 | 8.00 | 3.26 |
| SHDF | -3.38 | -1.30 | -15.97 | -1.29 |

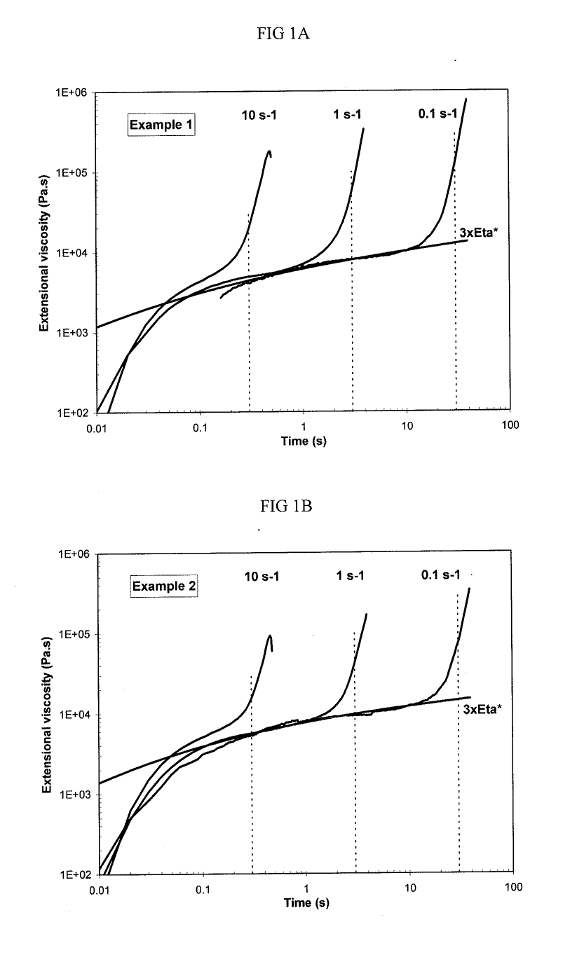

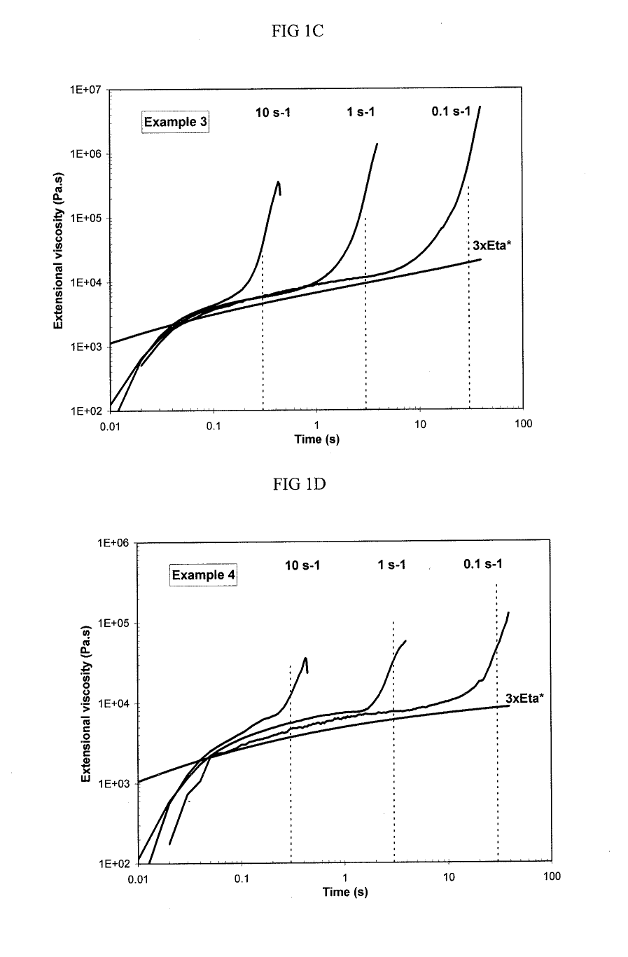

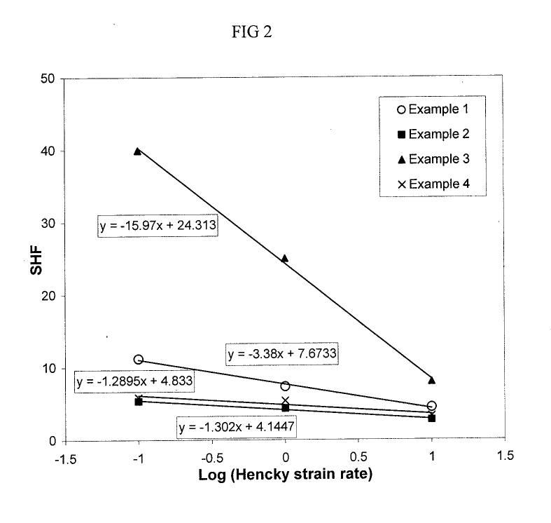

A graph of the strain hardening factor for each of Examples 1-4 is shown in respective FIGS. 1A-1D. A graph of the strain hardening distribution factor for each of Examples 1-4 is shown in FIG. 2. A Mark-Houwink Plot for Examples 1-4 is shown in FIG. 3.

Table 3 below provides the materials used in Examples 5-6.

TABLE 3

| Material (abbrev) | Source |
|---|---|
| Polypropylene (PP) | |
| (additive-free, Mₙ of 55.1 kg/mol and a | |
| polydispersity of 5.4 ) | |
| Butyl lithium (BuLi, 2.0 M in hexanes) | Sigma-Aldrich |
| Dicumyl peroxide (DCP, 98%) | Sigma-Aldrich |
| Vinyl triethoxysilane (VTES, 97%) | Sigma-Aldrich |
| Dibutyltin dilaurate (DBTDL, 98%) | Alfa Aesar |

PP powder (3.5 g) is tumble-mixed with a solution of DCP (7 mg, 0.2 wt %) in VTES (0.175 g, 5 wt %) for 20 min. This mixture is reacted for 5 min under a nitrogen atmosphere within a recirculating, twin screw mini-extruder at 180° C. and a screw speed of 60 rpm, giving PP-g-VTES. PP-g-VTES samples for graft content analysis are purified from residual VTES by dissolving in refluxing xylene, precipitating from acetone, and drying under vacuum at 60° C. Grafted VTES contents are calculated from FT-IR integrations of the 1064-1094 cm⁻¹ absorbance of the silane relative to a 422-496 cm⁻¹ internal standard region originating from PP.

PP-g-VTES samples for GPC analysis are rendered inert by treatment with BuLi. A solution of PP-g-VTES (0.5 g) in dry xylene (35 ml) is backfilled with nitrogen and heated to reflux prior to the drop-wise addition of excess BuLi (1 ml, 2.5M in hexane). The solution is refluxed for 3 h prior to injecting aqueous NH₄Cl (2 ml, saturated) and recovering the polymer by precipitation into acetone and drying under vacuum at 60° C.

PP-g-VTES (1 g) is stabilized with 500 ppm Irganox-1010, 1000 ppm Irgafos-168 and 600 ppm calcium stearate and moisture-cured by melt-mixing DBTDL (5 μL) into thin films, and immersing in boiling water for 15 h. The films are dried under vacuum at 60° C., giving the long-chain branched (LCB) derivatives LCB-Si.

Instrumentation and Analysis. FT-IR spectra of purified films are acquired with a Nicolet Avatar 360 FTIR ESP instrument. TD-GPC analysis is conducted using a Polymer Labs PL 200 series detector equipped with a Precision Detectors (Model 2040) light scattering instrument, for which the 15° angle detector is used for calculation purposes. The viscometer is a Viscotek model 210R detector. The dn/dc value used for calculating molecular weights from the light scattering data is 0.104 mL/g. The samples are dissolved in 2,6-di-t-butyl-4-methylphenol (BHT) stabilized TCB at 160° C. for approximately 2.5 hours and filtered prior to analysis.

The insoluble material content of LCB-PP samples is determined by extracting cured products with refluxing xylenes from 120 mesh sieve cloth. Extraction solutions are stabilized with 100 ppm of BHT, and the procedure is conducted for a minimum of 2 hours, with longer times having no effect on the results. Unextracted material is dried under vacuum to constant weight, with insoluble content reported as a weight percent of the original LCB-PP sample.

Samples for rheological analysis are stabilized with 500 ppm Irganox-1010, 1000 ppm Irgafos-168 and 600 ppm calcium stearate. Oscillatory elastic (G′) and loss (G″) moduli are measured under a nitrogen atmosphere using a Reologica ViscoTech controlled stress rheometer equipped with 20 mm diameter parallel plates. The instrument is operated at 180° C. with a gap of 1 mm over frequencies 0.04-188 rad/s. Stress sweeps are acquired to ensure that all data are acquired within the linear viscoelastic regime. Creep and creep-recovery experiments are performed using the aforementioned instrument at 180° C. using a stress of 10 Pa. Extensional viscosity data are acquired at 180° C. using an SER Universal Testing Platform from Xpansion Instruments.

TABLE 4
Properties of unmodified PP, functionalized PP, and LCB-PP materials

| | | | Functionalized PP derivatives | | | | | | LCB derivatives | | | |
|---|---|---|---|---|---|---|---|---|---|---|---|---|
| | | | Graft | Peroxide | | | Average | | Insoluble | | | |
| | [DCP] | [Modifier] | Yield | Yield | Mₙ | | grafts | ηₒ | material | Mₙ | | ηₒ |
| Example | wt % | wt % | wt % | mol/mol | kg/mol | PDI | per chain | kPa · s | wt % | kg/mol | PDI | kPa · s |
| A. | Unmodified | | — | — | 55.1 | 5.4 | — | 2.2 | — | — | — | — |
| | | | PP-g-VTES | | | | | | LCB—Si | | | |
| 5 (or C) | 0.20 | VTES | 0.7 | 3.0 | 28.6 | 3.5 | 1.1 | 0.4 | 0.1 | 37.1 | 10.5 | 38.6 |
| | | 5.0 | | | | | | | | | | |
| 6 (or D) | 0.50 | VTES | 1.4 | 2.4 | 22.3 | 3.5 | 1.7 | 0.2 | 12.0 | 27.6^{a} | 9.0^{a} | N/A |
| | | 5.0 | | | | | | | | | | |

^{a}Xylene-soluble fraction

Reaction of PP with 0.2 wt % DCP and 5 wt % VTES (Example 5, Table 4) results in substantial Mₙ and polydispersity reductions. This is consistent with the principles of controlled PP degradation, in which high molecular weight chains are statistically more likely to engage in hydrogen atom abstraction, thereby leading to a disproportionate amount of macro-radical scission compared to smaller chains within the distribution. Radical degradation is accompanied by the grafting of 0.7 wt % VTES (0.037 mmole/g), which for a polymer of Mₙ=28.6 kg/mol, amounts to an average of 1.1 trialkoxysilane groups for each chain within PP-g-VTES-C.

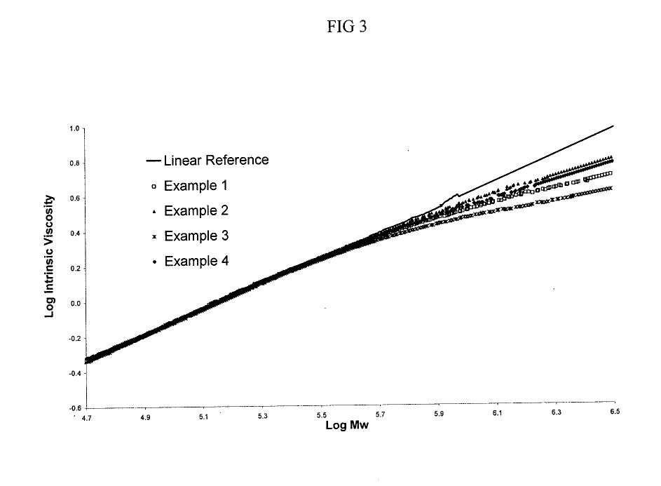

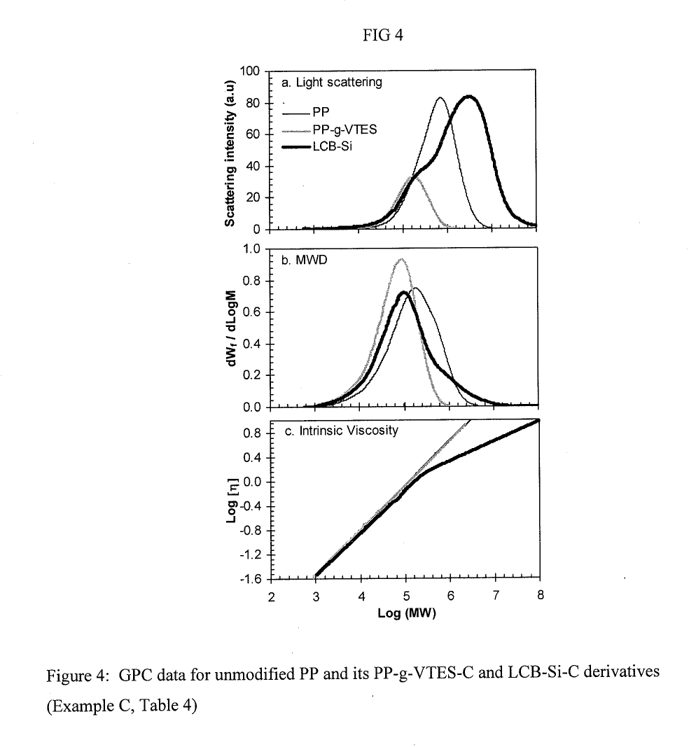

Lewis acid catalyzed moisture curing of PP-g-VTES-C gives a branched derivative, LCB-Si—C, that is completely soluble in boiling xylene—FT-IR analysis of the 0.1 wt % of extraction residue reveals no evidence of PP. The expected increase in Mₙ brought on by the cross-linking of pendant silane groups is accompanied by an increase in polydispersity from 3.5 to 10.5 (Example 5, Table 4). The light scattering data plotted in FIG. 4a, and the molecular weight distributions plotted in FIG. 4b, show that moisture-curing raises the molecular weight of a significant fraction of PP-g-VTES chains, but has no substantial affect on the majority chain population.

The data suggests that the non-uniform cure performance of PP-g-VTES-C (Example 5) is the result of a non-uniform distribution of silane grafts.

FIGS. 4a-4c are graphs showing GPC data for example 5 (also referred to as Example C). The Mark-Houwink plots presented in FIG. 4c provide further insight into the structure of LCB-Si derivatives. Whereas unmodified PP and PP-g-VTES generate linear double-log plots of [η] versus MW, LCB-Si—C demonstrates significant curvature beyond MW=10⁵. This is unambiguous evidence of branching within moisture-cured chains, which produce a lower solution viscosity than a linear polymer of equivalent molecular weight. The intrinsic viscosities of low molecular weight LCB-Si—C material are depressed slightly, indicating that some branching exists within this chain population. Taken together, the GPC data show that silylation/moisture curing does not give unimodal branching distributions, but it can provide much greater uniformity than a single-step coagent-based technique.

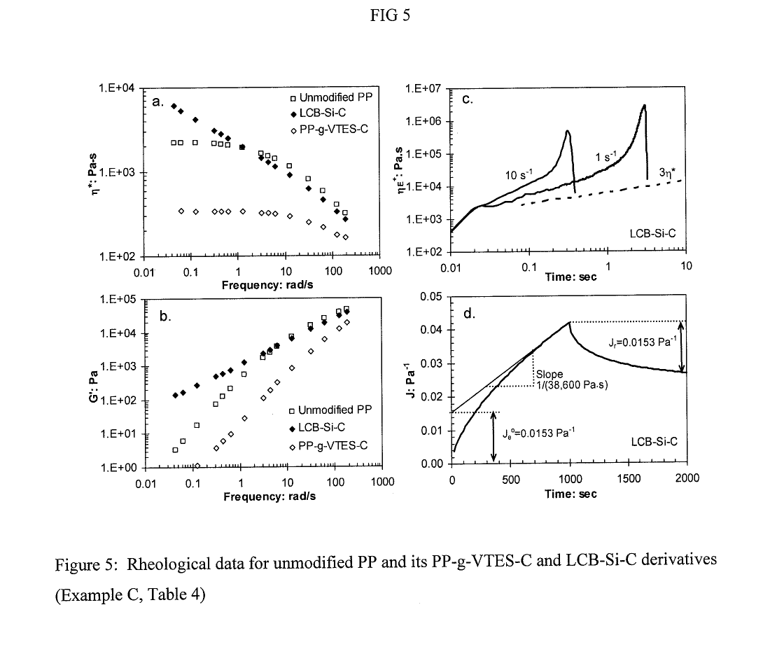

FIGS. 5a-5d show rheological data for Example 5 (or Example C). The rheological data presented in FIGS. 5a-5d demonstrates the benefits derived from the more balanced branching distribution produced by the LCB-Si approach. Unmodified PP and PP-g-VTES-C exhibit melt flow properties that are consistent with a linear structure. Both materials reach a terminal flow condition, with G′ scaling with ω² below 0.13 rad/s for PP and 0.44 rad/s for its silylated derivative. In contrast, the moisture-cured sample, LCB-Si—C, shows no evidence of a Newtonian plateau, as G′ did not enter the terminal region within the observable frequency range. Branch entanglements are equally influential under extensional deformations, as LCB-Si—C exhibits strong, progressive strain hardening to a comparatively high elongation (FIG. 5c). Creep compliance analysis produces a steady-state viscosity measurement of 38.6 kPa·s within 1000 seconds, after which a substantial elastic recovery is observed (FIG. 5d).

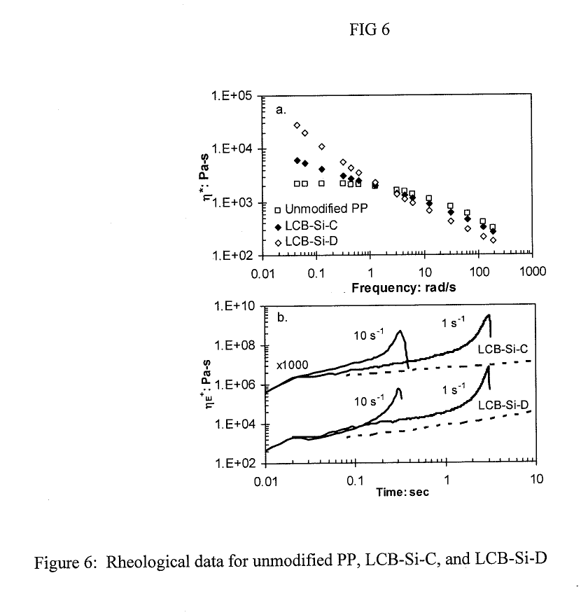

In an effort to generate branching amongst the entire population of LCB-Si chains, the amount of bound VTES is increased by raising the concentration of initiator (monomer conversions were relatively low, leaving little scope for changing VTES concentration). This is shown in example 6 (also referred to as example D) in Table 4. This gives sample PP-g-VTES-D, whose VTES content of 1.4 wt % and Mₙ of 22.3 kg/mol amounts to an average of 1.7 silane grafts per chain (Table 4). Rheological data for Example 6 (Example D) is shown in FIGS. 6a and 6b. Although these measures might indicate that a greater fraction of PP chains are affected by radical activity, moisture-curing produces 12 wt % gel along with 88 wt % of xylene-soluble matrix material whose Mₙ is 27.6 kg/mol. High-frequency η* values for unfractionated LCB-Si-D are less than those of the parent material (FIG. 6a), owing to a relatively low matrix molecular weight, whereas low-frequency values are dominated by the entanglement effects imposed by the sample's gel fraction. No steady-state could be achieved within 1000 sec of a creep compliance test, and the sample demonstrated extensive strain hardening when subjected to an extensional deformation (FIG. 6b)

It is specifically intended that the present disclosure not be limited to the embodiments and illustrations contained herein, but include modified forms of those embodiments including portions of the embodiments and combinations of elements of different embodiments as come within the scope of the following claims.

We claim:

1. A polymer composition comprising:
a propylene-based polymer having a strain hardening distribution factor (SHDF) less than 0, wherein the SHDF is the slope of the linear regression fit of the strain hardening factor as a function of the logarithm to the basis 10 of the Hencky strain rates between 10 s⁻¹ and 0.1 s⁻¹.

2. The polymer composition of claim 1 having a strain hardening factor (SHF) greater than 1.5 at Hencky strain rates between 10 s⁻¹ and 0.1 s⁻¹ at 180° C., wherein the SHF is the ratio of the extensional viscosity to three times of the shear viscosity at the same measurement time and at the same temperature.

3. The polymer composition of claim 1 having a weight averaged long chain branching index g′_{lcb} less than 0.99 for M_{w} from about 150,000 to about 1,000,000.

4. The polymer composition of claim 1 wherein the propylene-based polymer comprises a high molecular weight (HMW) component and a low molecular weight (LMW) component, the HMW component comprising a higher level of long chain branching than the LMW component.

5. The polymer composition of claim 1 wherein the polymer composition is substantially gel-free.

6. The polymer composition of claim 1 comprising a silane-coupled propylene-based polymer.

7. A process for producing a polymer composition comprising:
moisture curing a silane-grafted propylene-based polymer in the presence of a sulfonic acid; and
forming a silane-coupled propylene-based polymer having a strain hardening distribution factor (SHDF) less than 0, wherein the SHDF is the slope of the linear regression fit of the strain hardening factor as a function of the logarithm to the basis 10 of the Hencky strain rates between 10 s⁻¹ and 0.1 s⁻¹.

8. The process of claim 7 comprising in situ moisture curing the silane-grafted propylene-based polymer.

9. A foam composition comprising:
a propylene-based polymer having a strain hardening distribution factor (SHDF) less than 0, wherein the SHDF is the slope of the linear regression fit of the strain hardening factor as a function of the logarithm to the basis 10 of the Hencky strain rates between 10 s⁻¹ and 0.1 s⁻¹; and
the foam composition having a density from about 5 kg/m³ to about 850 kg/m³.

10. The foam composition of claim 9 comprising a silane-coupled propylene-based polymer.
